(19) United States
(12) Patent Application Publication
(10) Pub. No.: US 2017/0032685 A1
(43) Pub. Date: Feb. 2, 2017

(54) AIRSPACE INFORMATION PROCESSING DEVICE, AIRSPACE INFORMATION PROCESSING METHOD, AND NON-TRANSITORY COMPUTER-READABLE MEDIUM STORING AIRSPACE INFORMATION PROCESSING PROGRAM

(71) Applicant: NEC Corporation, Tokyo (JP)

(72) Inventor: Masahiko ISHIDA, Tokyo (JP)

(73) Assignee: NEC Corporation, Tokyo (JP)

(21) Appl. No.: 15/124,791

(22) PCT Filed: Mar. 19, 2014
(86) PCT No.: PCT/JP2014/001563

§ 371 Date: Sep. 9, 2016

(51) Int. Cl. G08G 5/00

(52) U.S. Cl. CPC G08G 5/0095

(57) ABSTRACT

A vector generation unit selects, for each of three or more reference points set at locations spaced apart from each other on a sphere, a line segment to be drawn from each of the three or more reference points without intersecting another line segment, from among one or more line segments forming an airspace defined by a closed curve on the sphere, and generates, for each of the three or more reference points, a vector from the selected line segment to each of the reference points. An airspace recognition unit recognizes one of two regions on a true sphere as an outside of the airspace and recognizes the other region as the airspace, the two regions being separated by the closed curve, the one of the two regions including the vectors of more than half of the three or more reference points.

### TECHNICAL FIELD

The present invention relates to an airspace information processing device, an airspace information processing method, and a non-transitory computer-readable medium storing an airspace information processing program.

### BACKGROUND ART

Today, various navigation systems have been put into practice to monitor vehicles on the Earth. In order to manage the operation of aircraft whose travel distance is longer than other carriers, it is necessary to calculate the azimuth and distance of the aircraft in a wide area. Aircraft navigation systems are generally required to process large-scale spatial information accurately and effectively in a wide area such as a country's territory and air space, or a flight information region (FIR).

For example, each air route of aircraft or the like can be represented by a line segment connecting two points on a true sphere. In this case, in order to ensure the security of the aircraft or the like, it is extremely important to determine whether or not two air routes intersect with each other. Further, each aircraft flies in an airspace in which the operation of the aircraft is allowed in the airspace set in the air, thereby ensuring the security of the aircraft. In this case, if adjacent airspaces overlap one another, a plurality of aircraft enter into the overlapping airspace, which poses a problem in terms of security. Accordingly, it is necessary for the navigation systems mentioned above to appropriately design the airspace for ensuring the security of the aircraft.

As an example of such navigation systems, a method for determining a positional relationship to determine whether an arbitrary point is inside or outside a polygon on the Earth has been proposed. In this example, it is determined which one of right and left regions is an airspace by taking into consideration a search direction of each side of a polygon (in other words, a circumferential direction of a closed curve) for defining an airspace.

Japanese Patent Application No. 2013-271712 proposes a technique for detecting, for various airspaces, an intersection point between line segments forming each airspace, and determining whether a vehicle is on the inside or outside of the airspace.

### CITATION LIST

### Patent Literature

### [Patent Literature 1] Japanese Unexamined Patent Application Publication No. 2012-88902

### SUMMARY OF INVENTION

### Technical Problem

However, the present inventor has found that the above-mentioned techniques have the following problems. That is, depending on flight rules or airspace design specifications, it may be required to treat a large airspace extending across countries or continents. In this case, for example, it can be assumed that the circumferential direction of a closed curve for defining an airspace differs from country to country, or differs from airspace to airspace. To deal with this, the technique disclosed in Patent Literature 1 takes into consideration the circumferential direction of a closed curve (the probing direction of each side of a polygon), but does not take into consideration how to deal with a case where the direction of a closed curve for defining an airspace to be treated varies. If a plurality of airspaces including airspaces defined by closed curves with different circumferential directions are treated by the technique disclosed in Patent Literature 1, an unacceptable error in airspace design, such as false recognition as to the inside or outside region of an airspace due to a difference in the circumferential direction, may occur.

The present invention has been made in view of the above-mentioned circumstances, and an object of the present invention is to treat, in a unified manner, a plurality of airspaces each having an unspecified circumferential direction.

### Solution to Problem

An airspace information processing device according to an aspect of the present invention includes: vector generation means for selecting, for each of three or more reference points set at locations spaced apart from each other on a sphere, a line segment to be drawn from each of the three or more reference points without intersecting another line segment, from among one or more line segments forming an airspace defined by a closed curve on the sphere, and generating, for each of the three or more reference points, a vector from the selected line segment to each of the reference points; and airspace recognition means for recognizing one of two regions on a true sphere as an outside of the airspace and recognizing the other region as the airspace, the two regions being separated by the closed curve, the one of the two regions including the vectors of more than half of the three or more reference points.

An airspace information processing method according to another aspect of the present invention includes: reading information indicating three or more reference points set at locations spaced apart from each other on a sphere; reading information indicating a line segment forming an airspace defined by a closed curve formed of one or more line segments on the sphere; selecting, for each of the reference points, a line segment to be drawn from each of the reference points to the one or more line segments without intersecting another line segment; generating, for each of the reference points, a vector from the selected line segment to each of the reference points; and recognizing one of two regions on a true sphere as an outside of the airspace and recognizing the other region as the airspace, the two regions being separated by the closed curve, the one of the two regions including the vectors of more than half of the three or more reference points.

An airspace information processing program according to still another aspect of the present invention causes a computer to execute: processing for reading information indicating three or more reference points set at locations spaced apart from each other on a sphere; processing for reading information indicating a line segment forming the airspace defined by a closed curve formed of one or more line segments on the sphere; processing for selecting, for each of the reference points, a line segment to be drawn from each of the reference points to the one or more line segments without intersecting another line segment; processing for generating, for each of the reference points, a vector from the selected line segment to each of the reference points; and processing for recognizing one of two regions on a true sphere as an outside of the airspace and recognizing the other region as the airspace, the two regions being separated by the closed curve, the one of the two regions including the vectors of more than half of the three or more reference points.

### Advantageous Effects of Invention

According to the present invention, a plurality of airspaces each having an unspecified circumferential direction can be treated in a unified manner.

### BRIEF DESCRIPTION OF DRAWINGS

FIG. 1 is a diagram showing a line segment connecting two points on a true sphere;

FIG. 2 is a diagram showing a circle on the true sphere;

FIG. 3 is a diagram showing an arc on the true sphere when the direction from a start point to an end point of the arc is counterclockwise;

FIG. 4 is a diagram showing an arc on the true sphere when the direction from a start point to an end point of the arc is clockwise;

FIG. 5 is a diagram showing an example of an airspace provided on the true sphere;

FIG. 6 is a diagram schematically showing a basic configuration of an airspace information processing device according to a first exemplary embodiment;

FIG. 7 is a diagram showing a configuration of an airspace information processing device as an example of the airspace information processing device including a peripheral device;

FIG. 8 is a flowchart showing an airspace information processing operation of the airspace information processing device according to the first exemplary embodiment;

FIG. 9 is a diagram showing examples of reference points in the airspace information processing device according to the first exemplary embodiment;

FIG. 10 is a flowchart showing vector generation processing in the airspace information processing device according to the first exemplary embodiment;

FIG. 11 is a diagram showing vector generation in a crescent-shaped airspace sandwiched between two arcs;

FIG. 12 is a diagram showing vector generation in the crescent-shaped airspace sandwiched between two arcs;

FIG. 13 is a diagram showing vector generation in the crescent-shaped airspace sandwiched between two arcs;

FIG. 14 is a diagram showing vector generation in a circular airspace;

FIG. 15 is a diagram showing vector generation in the circular airspace;

FIG. 16 is a diagram showing vector generation in the circular airspace;

FIG. 17 is a diagram showing vector generation in a rectangular airspace surrounded by four line segments;

FIG. 18 is a diagram showing vector generation in the rectangular airspace surrounded by four line segments;

FIG. 19 is a diagram showing vector generation in the rectangular airspace surrounded by four line segments;

FIG. 20 is a flowchart showing airspace recognition processing in the airspace information processing device according to the first exemplary embodiment;

FIG. 21 is a table showing airspace determination conditions in the airspace information processing device according to the first exemplary embodiment;

FIG. 22 is a diagram showing an example of a positional relationship between a closed curve and each reference point in Case 1;

FIG. 23 is a diagram showing an example of a positional relationship between a closed curve and each reference point in Case 2;

FIG. 24 is a diagram showing an example of a positional relationship between a closed curve and each reference point in Case 3;

FIG. 25 is a diagram showing an example of a positional relationship between a closed curve and each reference point in Cases 4 and 5;

FIG. 26 is a diagram showing a positional relationship between a closed curve and each reference point in Cases 6 and 9;

FIG. 27 is a diagram showing an example of a positional relationship between a closed curve and each reference point in Cases 7 and 8;

FIG. 28 is a diagram showing an example of a closed curve with no intersection point;

FIG. 29 is a diagram showing an example of a closed curve with an intersection point;

FIG. 30 is a flowchart showing an airspace information processing operation of an airspace information processing device 200 according to a second exemplary embodiment; and

FIG. 31 is a flowchart showing vector validity determination processing in an airspace information processing device 100 according to the first exemplary embodiment.

### DESCRIPTION OF EMBODIMENTS

Exemplary embodiments of the present invention will be described below with reference to the drawings. In the drawings, the same elements are denoted by the same reference numerals, and redundant explanations thereof are omitted as appropriate.

### First Exemplary Embodiment

An airspace information processing device 100 according to a first exemplary embodiment will be described. The airspace information processing device 100 is a device that treats, in a unified manner, pieces of information on a plurality of airspaces which are each defined by one or more line segments and have an unspecified circumferential direction.

First, line segments which form a closed curve will be described. Line segments on a true sphere can be roughly divided into the following three types.

### A Line Segment Connecting Two Points on the True Sphere in the Shortest Distance

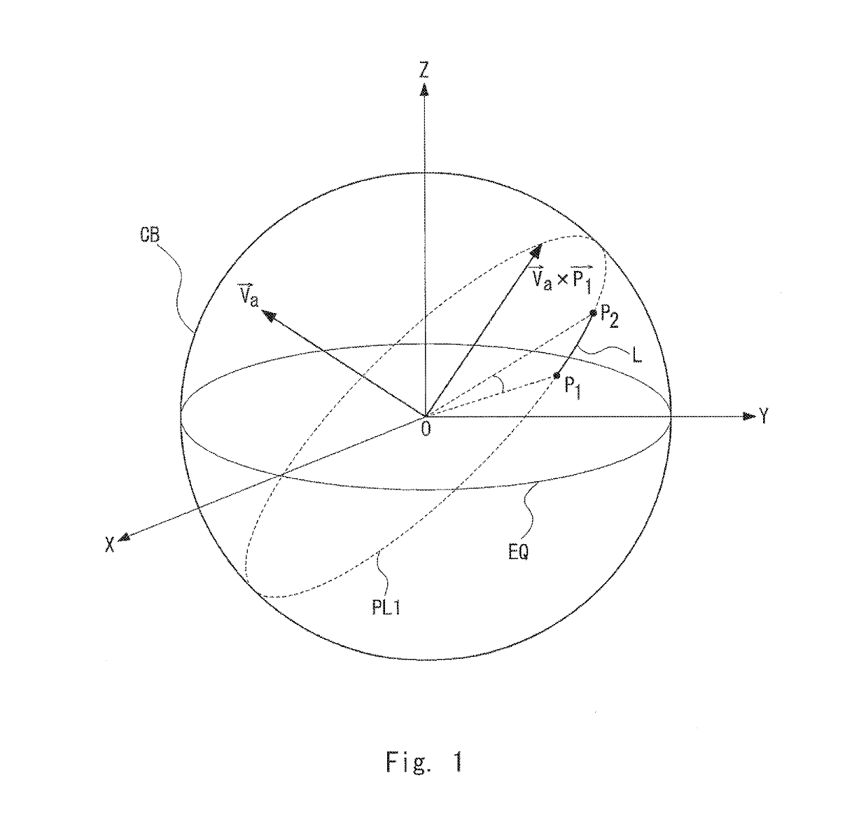

A line segment connecting a point P₁ and a point P₂ to each other on a true sphere CB (on the ground) will be described. FIG. 1 is a diagram showing a line segment L connecting the point P₁ and the point P₂ to each other on the true sphere CB. Vₐ represents a unit normal vector with respect to a plane PL1 to which the line segment L connecting the point P₁ and the point P₂ to each other belongs. The plane PL1 is a plane including the center of the true sphere CB. EQ represents the equator of the true sphere CB. The unit normal vector Vₐ with respect to the plane PL1 is represented by the following formula (1).

$$\begin{matrix}[ Formula 1 ] & \\ \vec{{V}_{a}} = \frac{( \vec{{P}_{1}} \times \vec{{P}_{2}} )}{\vert \vec{{P}_{1}} \times \vec{{P}_{2}} \vert} & ( 1 )\end{matrix}$$

Assuming that P represents a point on the line segment L connecting the point P₁ and the point P₂ to each other on the true sphere CB and sₐ represents the cosine of the angle formed between the unit normal vector Vₐ and the position vector of the point P, sₐ is represented by the following formula (2).

[Formula 2]

(\vec{Vₐ}·\vec{P})=sₐ (2)

Since it is apparent that the unit normal vector Vₐ and the line segment L are orthogonal to each other, the cosine Sₐ is 0. Accordingly, the point P on the line segment L can be defined as a point that satisfies the following formula (3).

[Formula 3]

(\vec{Vₐ}·\vec{P})=0 (3)

### A Circle on the True Sphere

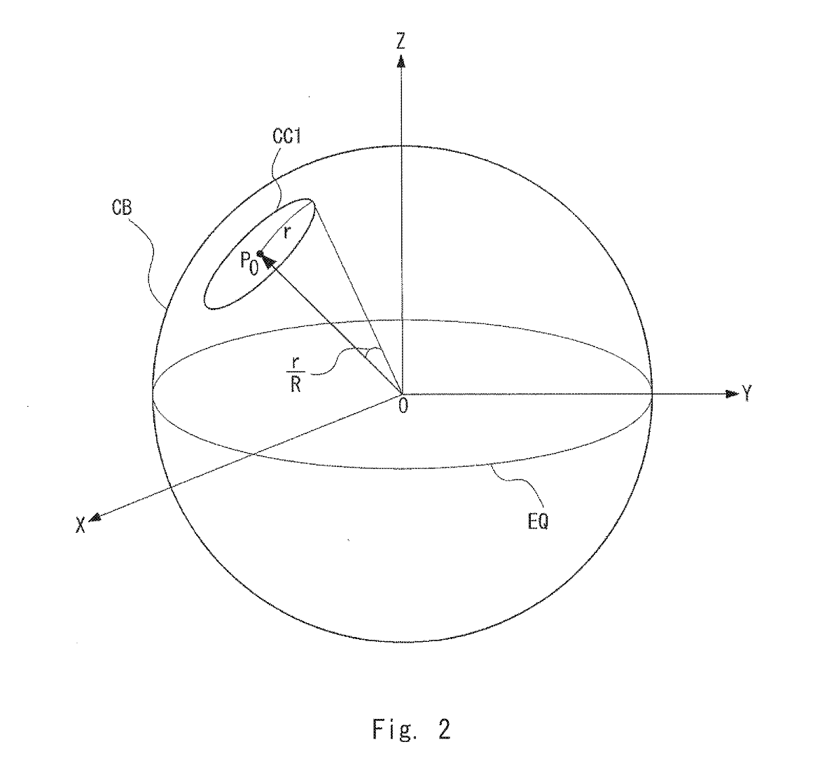

A circle on the true sphere CB will be described. FIG. 2 is a diagram showing a circle CC1 on the true sphere CB. The circle CC1 on the true sphere CB can be understood as a set of points at a distance r from a certain point P₀. The position vector of the point P on the circumference of the circle CC1 satisfies each vector equation in the following formula (4) using the position vector of the point P₀. R represents the radius of the true sphere CB. V_{d} represents a unit normal vector of a plane to which the circle CC1 belongs and coincides with the position vector of the point P₀.

[Formula 4]

\vec{V_{d}}=\vec{P₀}

(\vec{V_{d}}·\vec{P})=s_{d} (4)

s_{d} represents the cosine of the angle formed between the point P₀ and the point P on the true sphere CB, and is represented by the following formula (5).

$$\begin{matrix}[ Formula 5 ] & \\ {s}_{d} = cos ( \frac{r}{R} ) & ( 5 )\end{matrix}$$

### An Arc Connecting Two Points on the True Sphere

An arc on the true sphere CB will be described. The arc on the true sphere CB can be understood as a set of points at the distance r from the point P₀ on the true sphere CB.

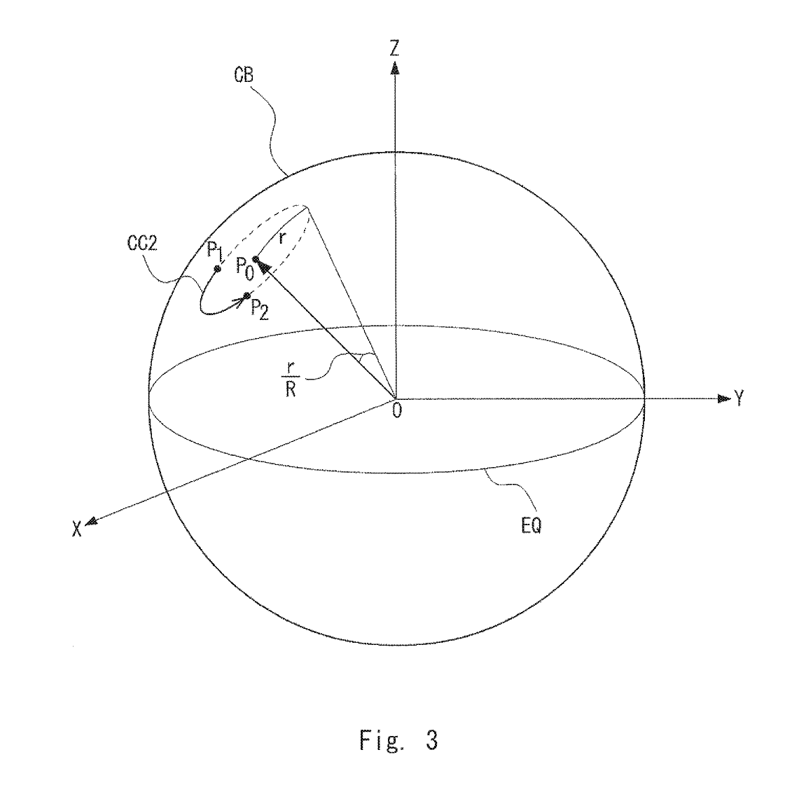

A case where the direction from a start point to an end point of the arc is counterclockwise will be described. FIG. 3 is a diagram showing an arc CC2 on the true sphere CB when the direction from the start point to the end point of the arc is counterclockwise. When the direction between the two points is counterclockwise, the position vector of the point P on the arc CC2 satisfies each vector equation of the following formula (6). R represents the radius of the true sphere CB. Vₑ represents a unit normal vector of a plane to which the arc CC2 belongs and coincides with the position vector of the point P₀.

[Formula 6]

\vec{Vₑ}=\vec{P₀}

(\vec{Vₑ}·\vec{P})=sₑ (6)

s_{d} represent the cosine of the angle formed between the point P₀ and the point P on the true sphere, and is represented by the following formula (7).

$$\begin{matrix}[ Formula 7 ] & \\ {s}_{e} = cos ( \frac{r}{R} ) & ( 7 )\end{matrix}$$

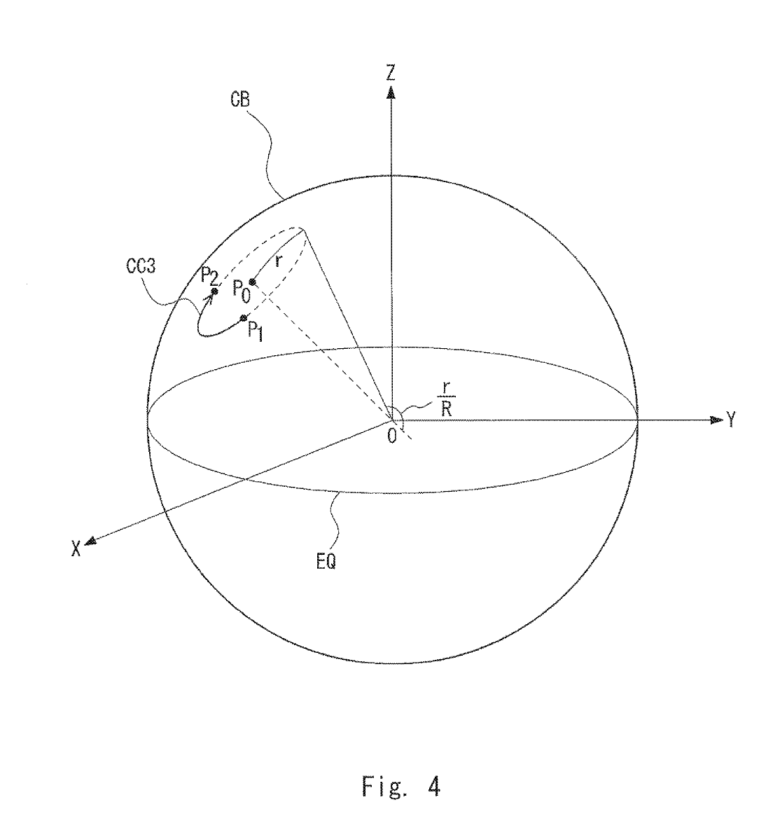

A case where the direction from a start point to an end point of an arc is clockwise will be described. FIG. 4 is a diagram showing an arc CC3 on the true sphere CB when the direction from the start point to the end point of the arc is clockwise. When the direction between the two points is clockwise, the position vector of the point P on the arc CC3 satisfies each vector equation of the following formula (8). R represents the radius of the true sphere CB. Vₑ represents a unit normal vector of a plane to which the arc CC3 belongs, and the direction of the unit normal vector is opposite to the direction of the position vector of the point P₀.

[Formula 8]

\vec{Vₑ}=−\vec{P₀}

(\vec{Vₑ}·\vec{P})=sₑ (8)

sₑ is equal to the cosine of the angle formed between the point P₀ on the true sphere CB and an arbitrary point P on the arc, and has a negative sign. sₑ is represented by the following formula (9)

$$\begin{matrix}[ Formula 9 ] & \\ {s}_{e} = - cos ( \frac{r}{R} ) & ( 9 )\end{matrix}$$

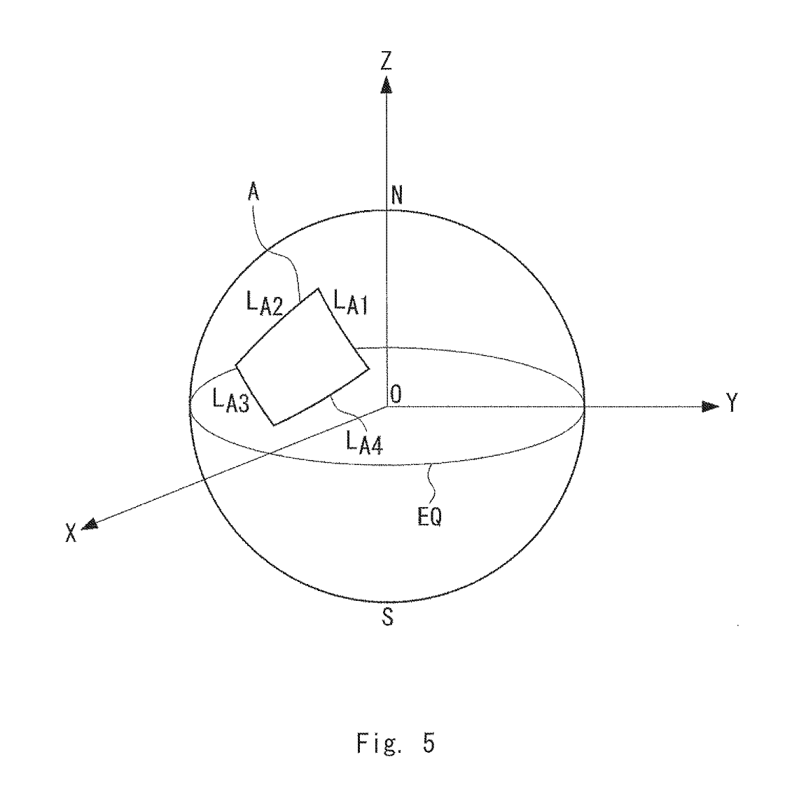

Next, an airspace set on the true sphere will be described. FIG. 5 is a diagram showing an example of the airspace provided on the true sphere CB. In FIG. 5, an airspace A is surrounded by a closed curve formed of line segments L_{A1} to L_{A4}, thereby separating the airspace A from an external region. The airspace shown in FIG. 5 is illustrated by way of example only. The number of line segments surrounding the airspace A may be one (i.e., a circle on the true sphere CB) or any number other than four. In the example shown in FIG. 5, when a vehicle travels counterclockwise while viewing the closed curve formed of the line segments L_{A1} to L_{A4} from the outside of the true sphere, the region that can be seen on the left side as viewed from the line segments on the true sphere is defined as the airspace A. Accordingly, in this case, the region on the true sphere that can be seen on the right side as viewed from the line segments is defined as a region outside of the airspace A.

In summary, it can be understood that, when an airspace is defined, the following two pieces of information are required.

### (1) Line Segment Information

Specification of one or more line segments surrounding the airspace.

### (2) Direction Information

Specification of a direction (counterclockwise or clockwise) when the closed curve formed of the one or more line segments surrounding the airspace is viewed from the outside of the true sphere.

However, it is assumed that the airspace information processing device 100 according to this exemplary embodiment treats a considerably large airspace on the true sphere. Accordingly, it is necessary to collectively treat pieces of airspace information created by different subjects, such as an organization, a corporation, a country, and the like.

In this case, a start point and an end point (for example, the points P₁ and P₂ shown in FIG. 1) of each line segment can be provided as line segment information to specify each of the line segments surrounding the airspace. Further, when a path connecting the start point and the end point is not uniquely defined, information for specifying a path for each line segment as shown in the above formula (3) can be added to the line segment information. In other words, the line segment information can be mathematically, uniquely defined. Therefore, even when the airspace definition rules vary among the organizations, corporations, countries, and the like that treat the airspace, it is sufficient to represent each line segment surrounding the airspace in any fashion. Thus, the difference in the line segment information poses no problem.

On the other hand, it is necessary to carefully treat the direction information for the following reason. That is, as for the direction information, the direction of the closed curve is artificially determined. Therefore, the direction of the closed curve may vary among organizations, corporations, countries, and the like that treat the airspace. For example, it can be assumed that the direction of the closed curve is specified as counterclockwise in a country A, while the direction of the closed curve is specified as clockwise in a country B. In this case, the direction of the closed curve is defined as counterclockwise in a system using the airspace information of the country A. Accordingly, if the line segment information created in the country B is input to a system of the country A to recognize the airspace, the system of the country A recognizes that the airspace indicated by the line segment information of the country B is outside of the airspace. That is, in such a case, false recognition of the airspace occurs.

In order to avoid this, it is possible to specify the direction information for each piece of line segment information created by different subjects, such as an organization, a corporation, a country, and the like. However, in existing systems, it is not assumed that a wide range of airspace is treated like in the airspace information processing device 100 according to this exemplary embodiment. Accordingly, the existing systems do not have any function for adding the direction information for specifying the direction of the closed curve to the line segment information for specifying the airspace. Even if the direction information is added, the amount of information to be input to the system increases, and if the direction information is erroneously specified, a problem similar to that described above arises.

The area of an airspace defined by a closed curve is generally smaller than half of the surface area of the Earth, as is obvious from the intended use thereof. Therefore, when the area of the airspace is compared with the area of the region outside of the airspace, a smaller area can be discriminated as being the airspace. However, a vast number of calculations are required to obtain the area of each region defined by a closed curve on the sphere, which is not suitable for processing of simply recognizing an airspace. Particularly when a plurality of airspaces are treated, a vast number of calculations are required merely for enabling the system to recognize an airspace, and thus it is not practical.

On the other hand, the airspace information processing device 100 according to this exemplary embodiment can recognize an airspace accurately with a small number of calculations based on the airspace information with various directions of closed curves. The airspace information processing device 100 will be described in detail below.

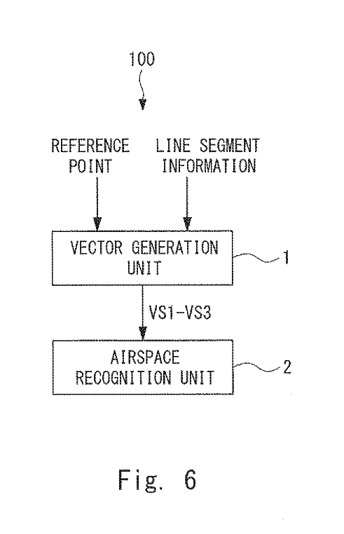

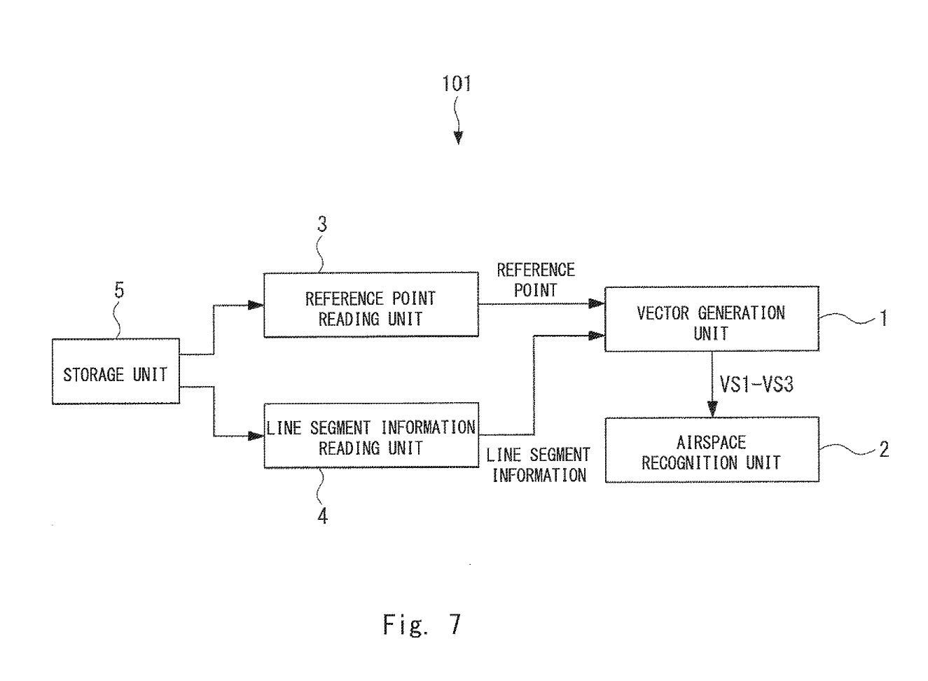

FIG. 6 is a diagram schematically showing the basic configuration of the airspace information processing device 100 according to the first exemplary embodiment. The airspace information processing device 100 includes a vector generation unit 1 and an airspace recognition unit 2. FIG. 7 is a diagram showing the configuration of an airspace information processing device 101 which is an example of the airspace information processing device including a peripheral device. The airspace information processing device 101 has a configuration in which a reference point reading unit 3, a line segment information reading unit 4, and a storage unit 5 are added to the airspace information processing device 100.

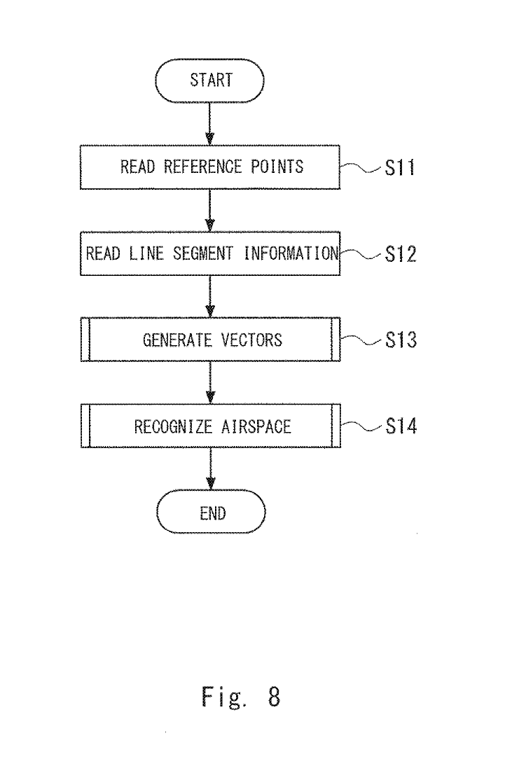

The operation of the airspace information processing device according to this exemplary embodiment will be described below. FIG. 8 is a flowchart showing the airspace information processing operation of the airspace information processing device 100 according to the first exemplary embodiment.

### Step S11: Reading of Reference Points

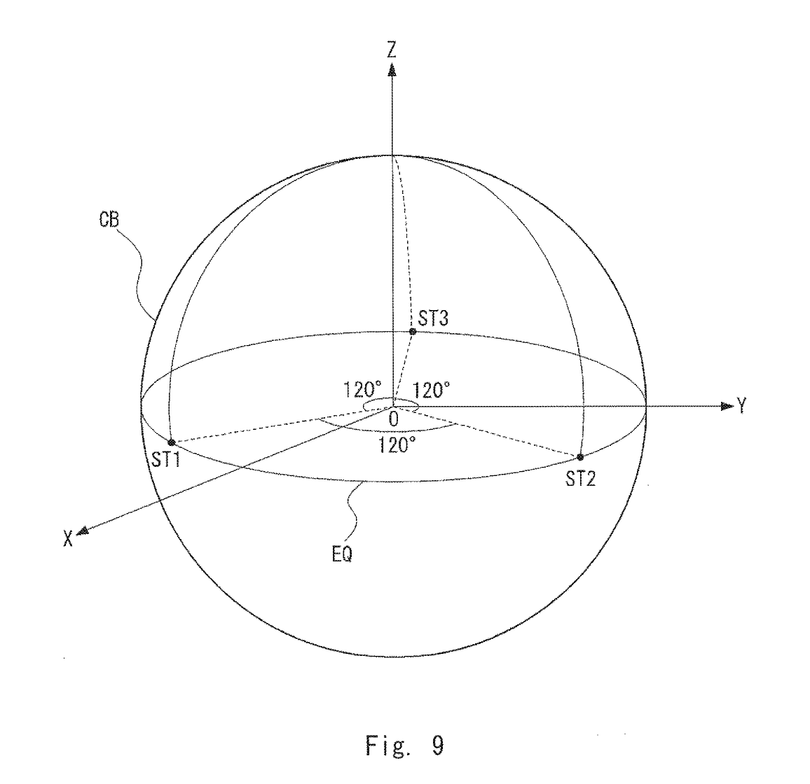

The vector generation unit 1 reads reference points. Specifically, the reference point reading unit 3 reads the reference points stored in the storage unit 5, and outputs a result of the reading to the vector generation unit 1. In this exemplary embodiment, at least three reference points are set on the sphere CB. Each reference point is set in such a manner that the distances between the reference points become substantially equal. FIG. 9 is a diagram showing examples of reference points ST1 to ST3 in the airspace information processing device 100 according to the first exemplary embodiment. Referring to FIG. 9, the reference points ST1 to ST3 are set on the equator of the sphere CB at longitude intervals of 120°.

### Step S12: Reading of Line Segment Information

The vector generation unit 1 reads the line segment information. Specifically, the line segment information reading unit 4 reads the line segment information about the airspace that is preliminarily stored in the storage unit 5, and outputs a result of the reading to the vector generation unit 1. In the example shown in FIG. 5, the line segment information reading unit 4 reads information indicating the line segments L_{A1} to L_{A4} of the airspace A.

### Step S13: Generation of Vectors

The vector generation unit 1 selects, for each of the reference points, a line segment to be drawn from each of the reference points without intersecting another line segment, from among the line segments L_{A1} to L_{A4}. A vector from the selected line segment to the corresponding reference point is generated for each of the reference points.

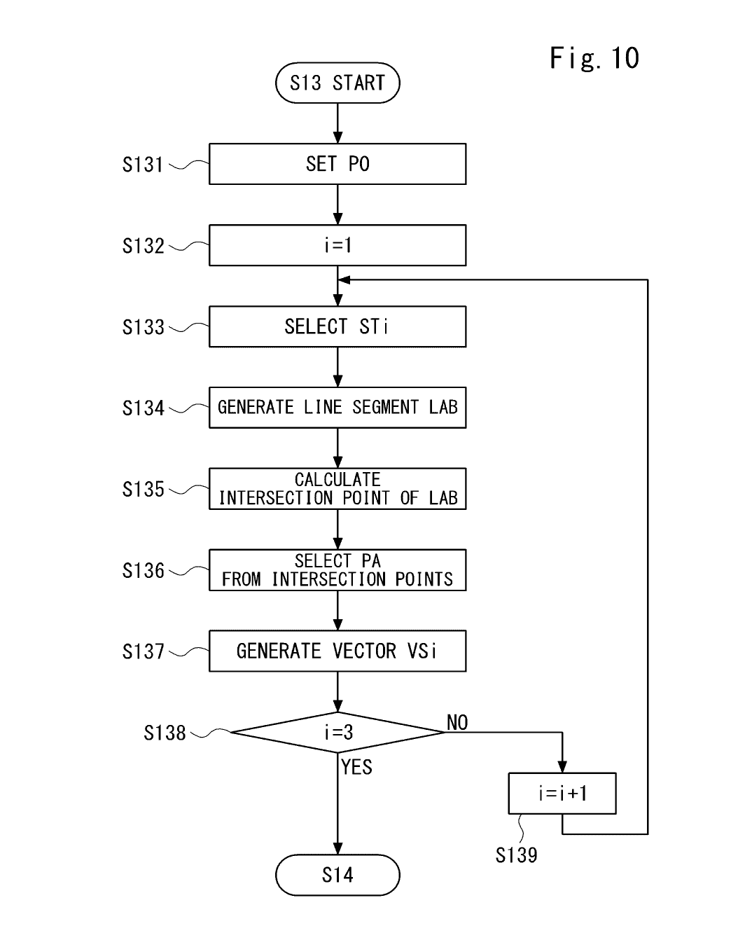

Step S13 will be described in more detail. FIG. 10 is a flowchart showing the vector generation process in the airspace information processing device 100 according to the first exemplary embodiment.

### Step S131

An arbitrary point P0 is set on any one of the line segments L_{A1} to L_{A4}.

### Step S132

In this case, the reference point is represented by STi (1≦i≦3). First, i is set to an initial value “1” (i=1).

### Step S133

The reference point STi is selected.

### Step S134

A line segment LAB is drawn from the point P0 to the reference point STi.

### Step S135

Intersection points between the line segment LAB and line segments other than the line segment on which the point P0 is set are calculated.

### Step S136

Among the intersection points obtained as described above, an intersection point closest to the reference point STi is selected as a point PA.

### Step S137

A vector VSi from the point PA to the reference point STi is generated.

### Step S138

It is confirmed whether i=3 holds. When i=3 holds, the process of Step S13 is completed.

### Step S139

When i<3 holds, “1” is added to “i” (i=i+1), and the processing returns to Step S132.

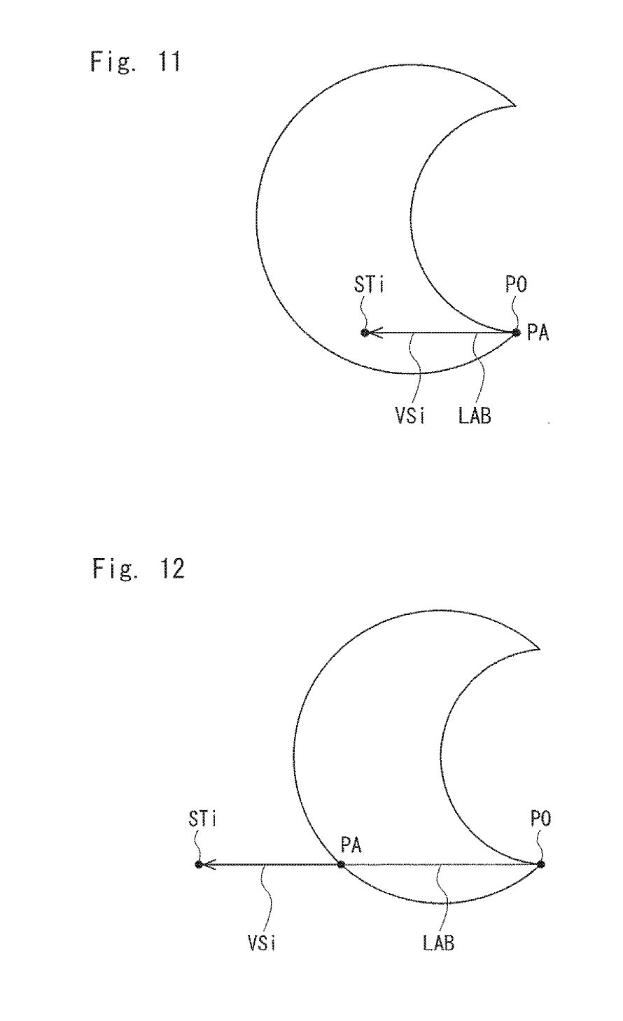

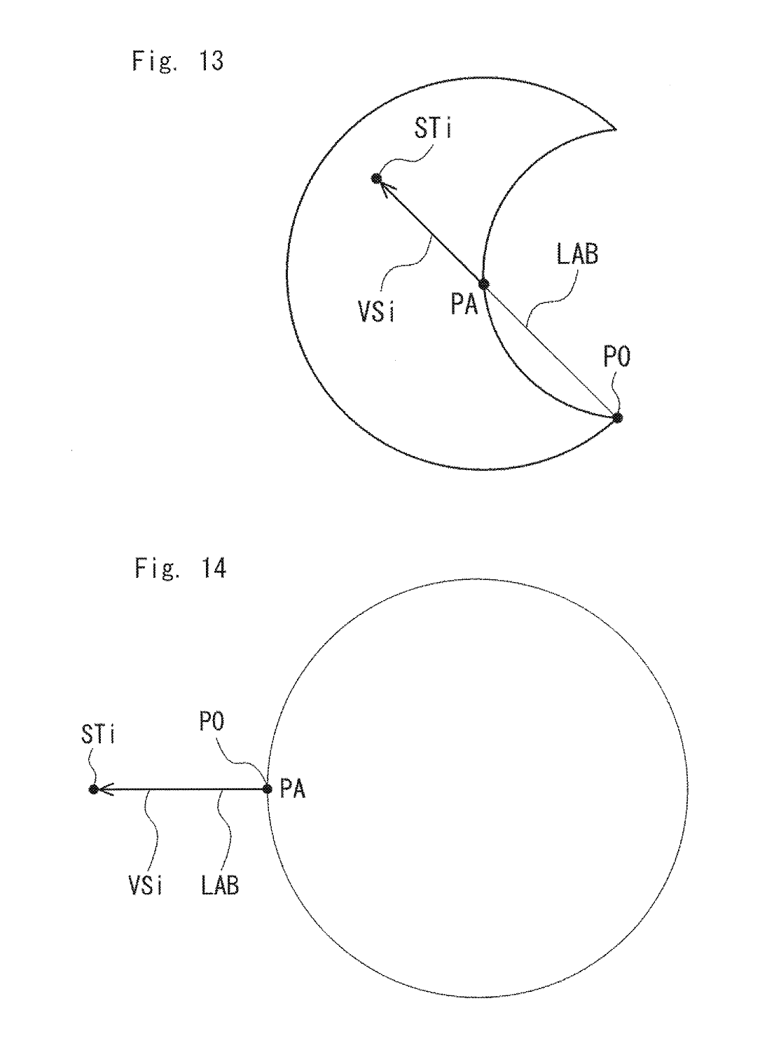

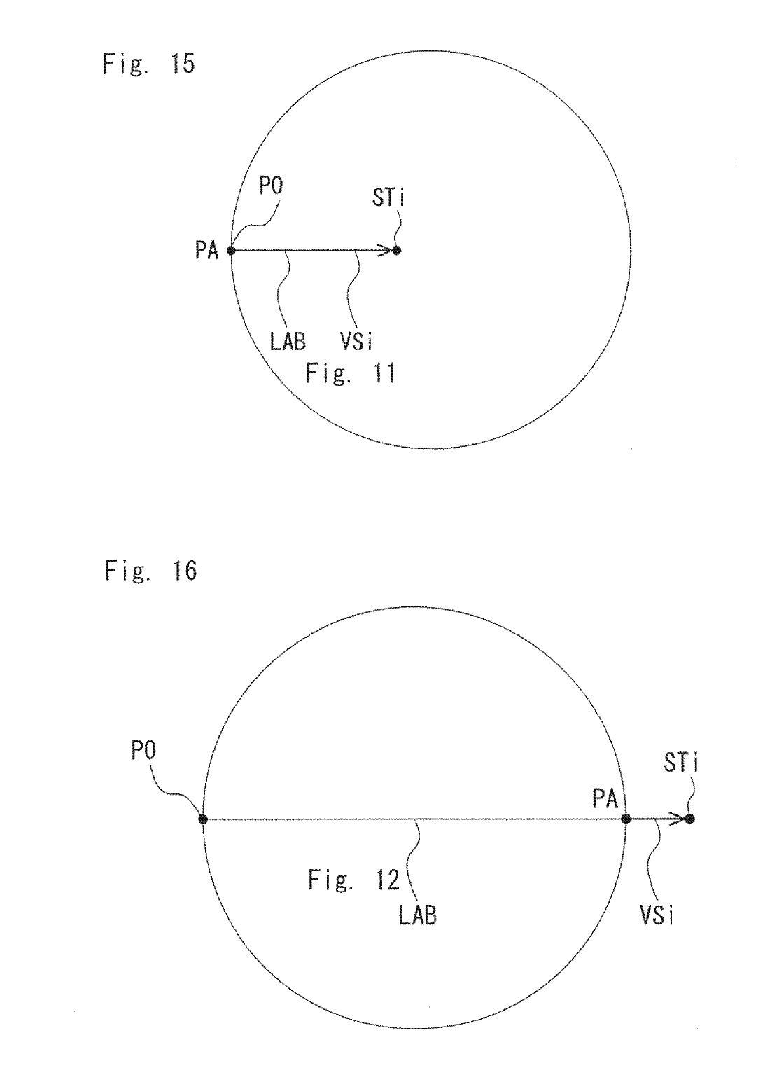

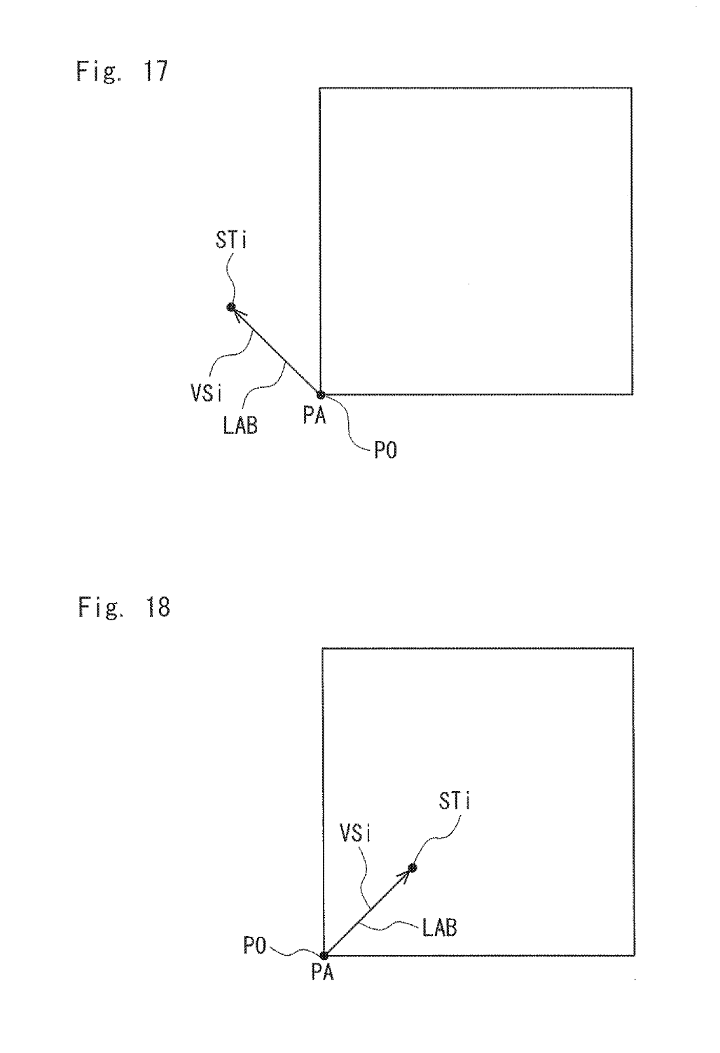

The vector generation in Step S13 described above can be carried out by Steps S131 to S139 described above. FIGS. 11 to 19 each show an example of the generation of vectors when the reference point ST1 is selected as described above. For simplification of the drawing, an airspace is approximately represented on a plane in FIGS. 11 to 19. FIGS. 11 to 13 are diagrams each showing the vector generation in a crescent-shaped airspace sandwiched between two arcs. FIGS. 14 to 16 are diagrams each showing the vector generation in a circular airspace. FIGS. 17 to 19 are diagrams each showing the vector generation in a rectangular airspace surrounded by four line segments.

### Step S14: Airspace Recognition

The airspace recognition unit 2 recognizes, as an outside of the airspace, one region including more than half of the reference points, in two regions on the true sphere that are separated by a closed curve, and recognizes the other region as the airspace. In other words, the airspace recognition unit 2 determines, based on the majority rule, which region includes a greater number of reference points, and determines the circumferential direction of the airspace.

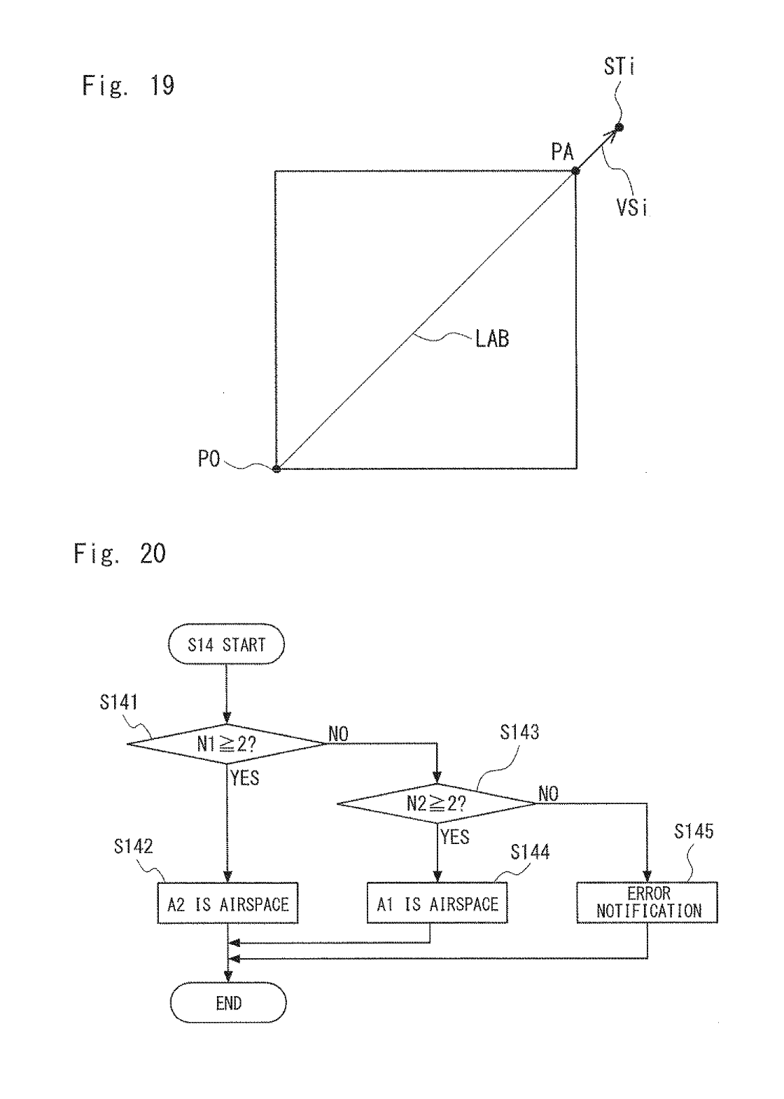

Step S14 will be described in more detail. FIG. 20 is a flowchart showing the airspace recognition processing in the airspace information processing device 100 according to the first exemplary embodiment.

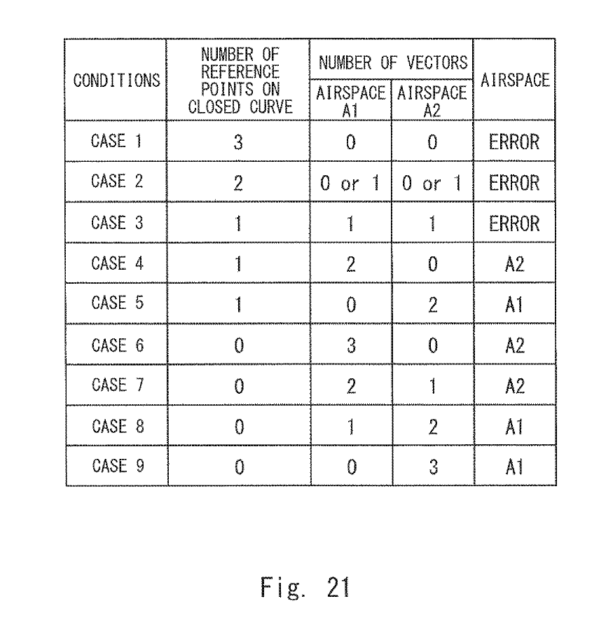

The two regions separated by the closed curve are defined as regions A1 and A2 which are located on the left and right sides, respectively, when the boundary between the regions is followed in the direction in which the airspace is defined. In this case, the conditions for determining which one of the regions A1 and A2 is the airspace include the following nine cases. FIG. 21 is a table showing the airspace determination conditions in the airspace information processing device 100 according to the first exemplary embodiment.

### Case 1

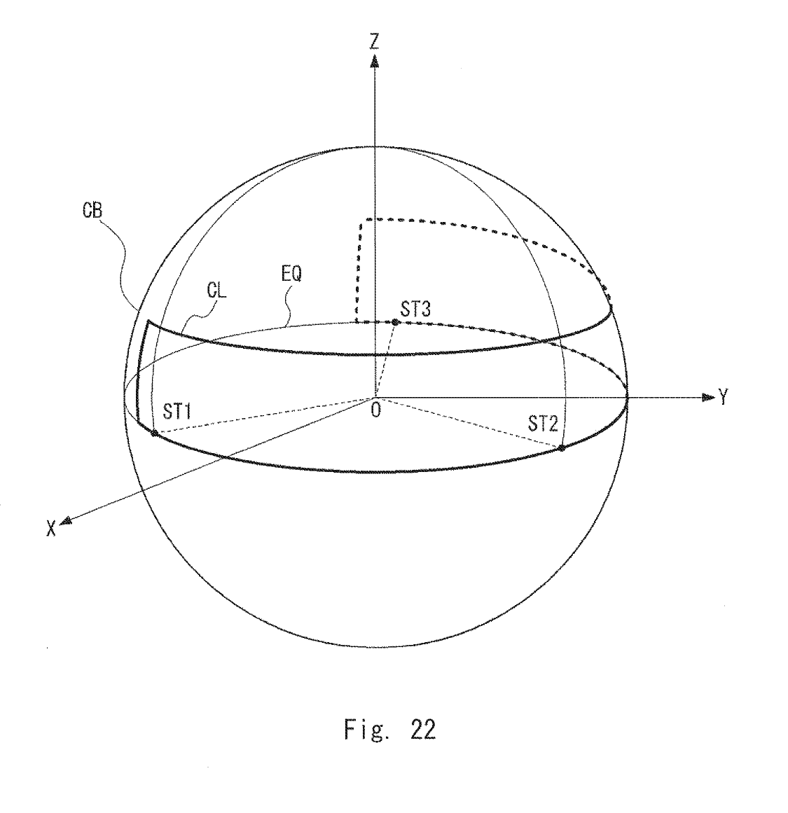

Case 1 is a case where the reference points ST1 to ST3 are present on a closed curve CL. FIG. 22 is a diagram showing an example of the positional relationship between the closed curve and each reference point in Case 1. In this case, no reference point is present in both of the region A1 and the region A2. Accordingly, the above-mentioned majority rule does not hold, and thus it is determined to be an error. However, in practice, a huge airspace where three reference points sufficiently spaced apart from each other are included in the closed curve corresponding to the boundary between the region A1 and the region A2 is inconceivable. Therefore, this error can be avoided by appropriately setting the reference points.

### Case 2

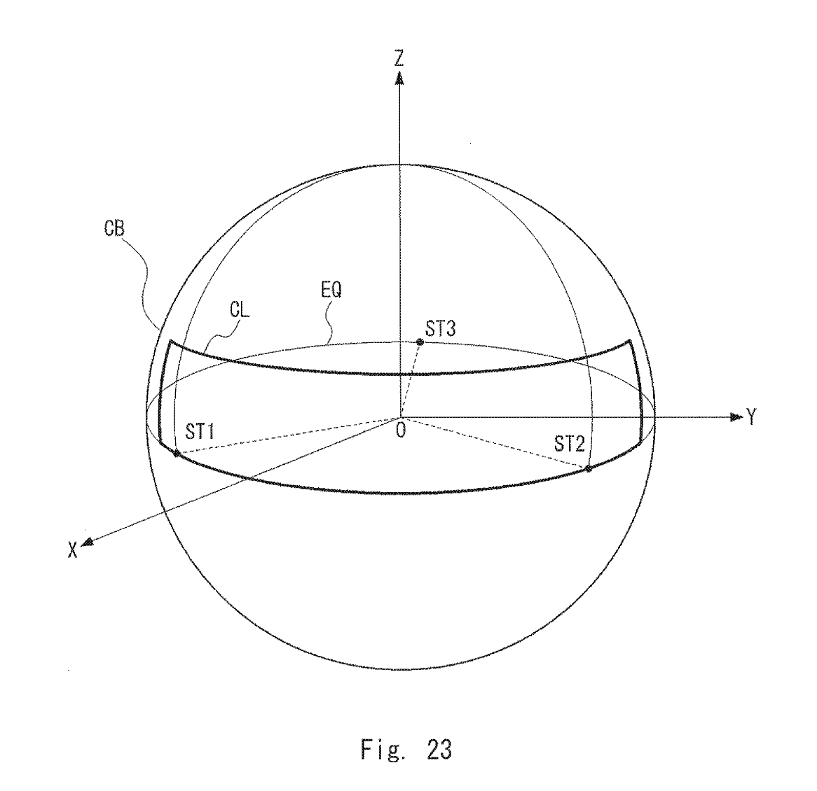

Two of the reference points ST1 to ST3 are present on the closed curve CL. FIG. 23 is a diagram showing an example of the positional relationship between the closed curve and each reference point in Case 2. In this case, one reference point is present in one of the regions A1 and A2, but the above-mentioned majority rule does not hold, and thus it is determined to be an error. However, in practice, like in Case 1, a huge airspace where two reference points are included in the closed curve corresponding to the boundary between the region A1 and the region A2 is inconceivable. Therefore, this error can be avoided by appropriately setting the reference points.

### Case 3

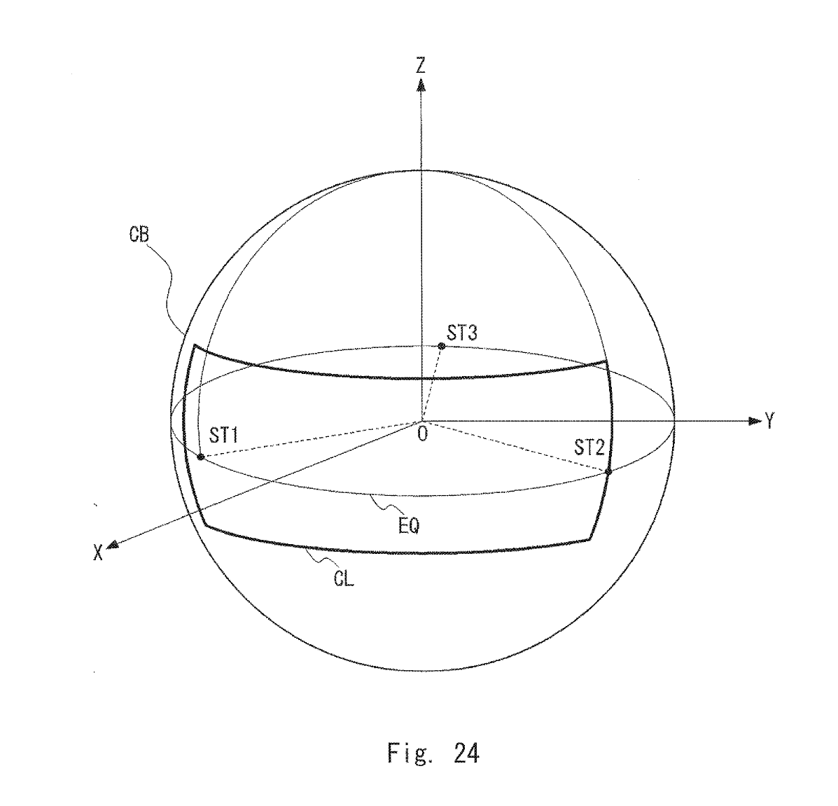

One of the reference points ST1 to ST3 is present on the closed curve CL. FIG. 24 is a diagram showing an example of the positional relationship between the closed curve and each reference point in Case 3. In this case, one reference point is present in each of the regions A1 and A2, but the above-mentioned majority rule does not hold, and thus it is determined to be an error. However, in this case, it can be considered that the region A1 and the region A2 are about the same size, but such a huge airspace that divides the true sphere into two regions is inconceivable. Therefore, this error can be avoided by appropriately setting the reference points.

### Case 4

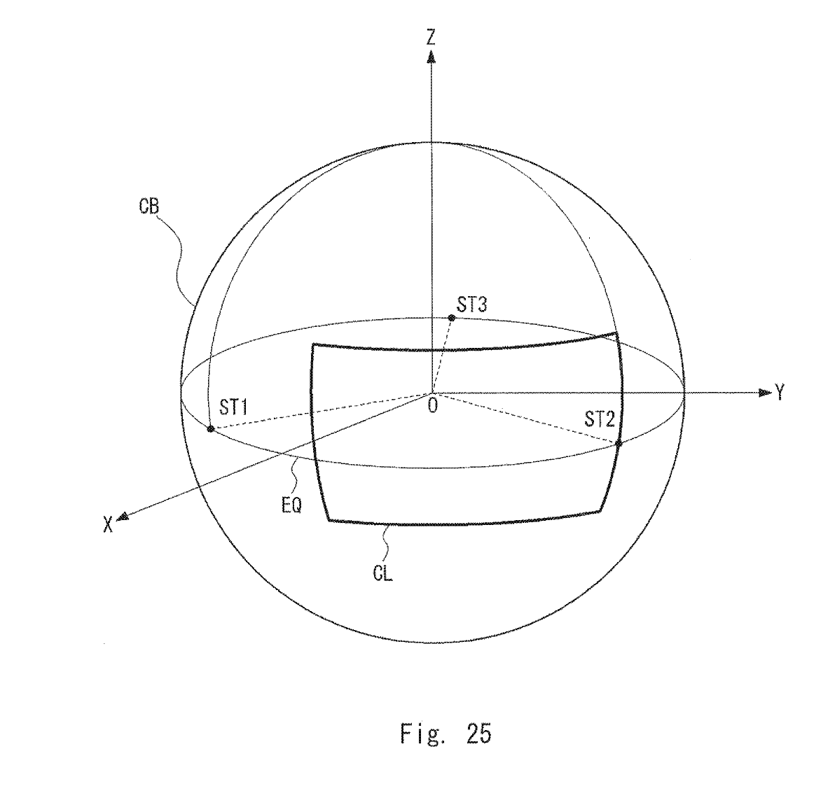

Case 4 is a case where one of the reference points ST1 to ST3 is present on the closed curve and the other two reference points are present in the region A1. FIG. 25 is a diagram showing an example of the positional relationship between the closed curve and each reference point in Cases 4 and 5. In this case, the majority rule holds and the region A2 is recognized as the airspace.

### Case 5

Case 5 is a case where one of the reference points ST1 to ST3 is present on the closed curve and the other two reference points are present in the region A2. In this case, the majority rule holds and the region A1 is recognized as the airspace.

### Case 6

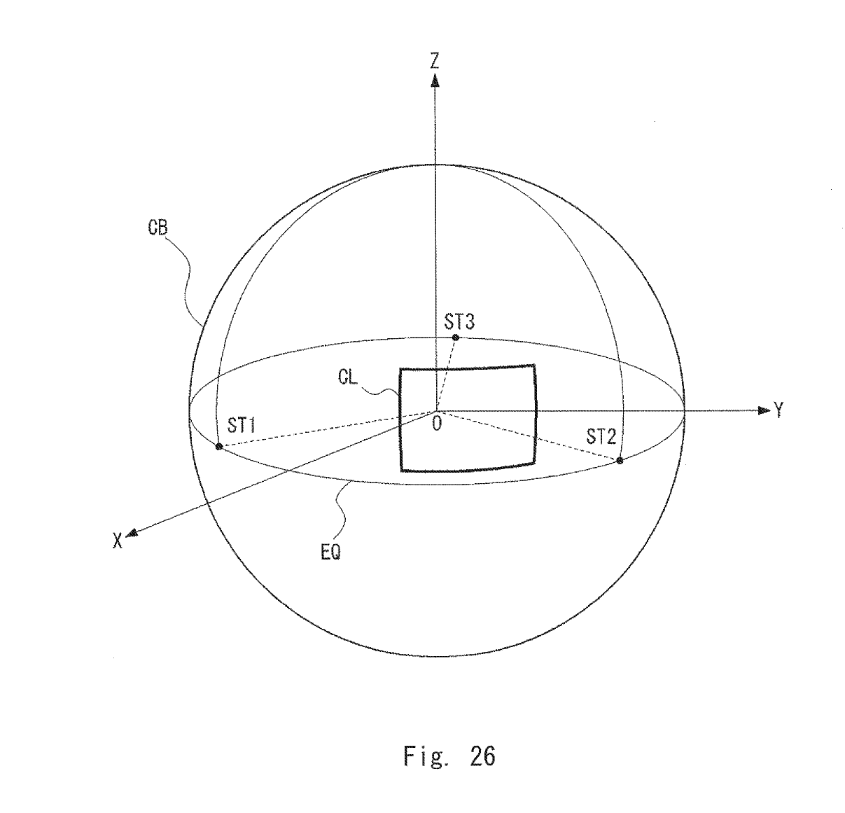

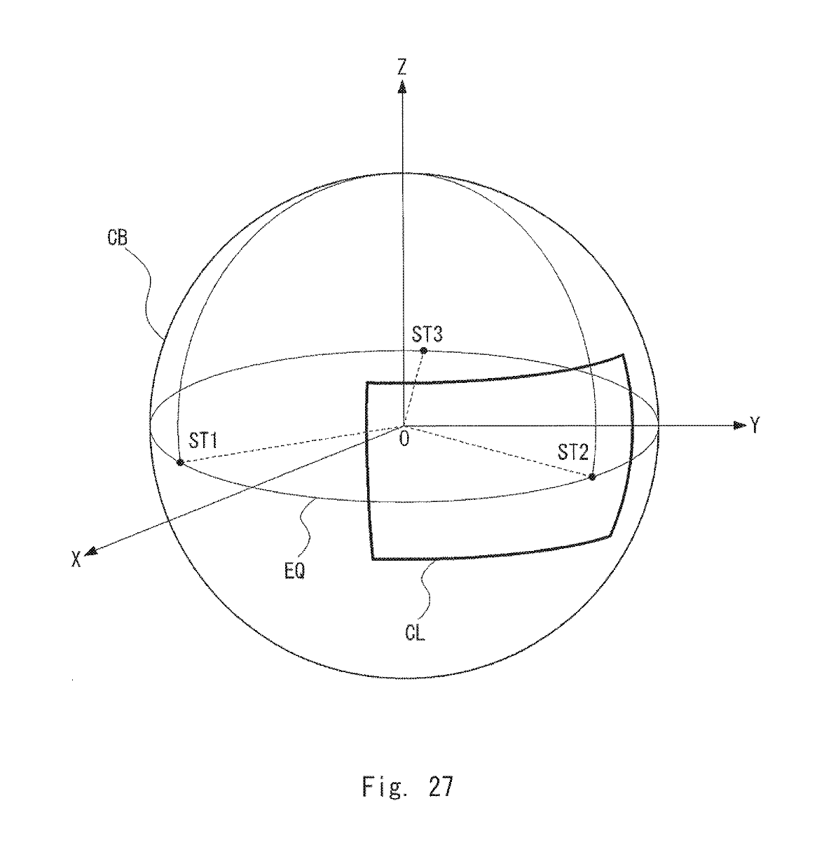

Case 6 is a case where three reference points are present in the region A1. FIG. 26 is a diagram showing an example of the positional relationship between the closed curve and each reference point in Cases 6 and 9. In this case, the majority rule holds and the region A2 is recognized as the airspace.

### Case 7

Case 7 is a case where two reference points are present in the region A1 and one reference point is present in the region A2. FIG. 26 is a diagram showing an example of the positional relationship between the closed curve and each reference point in Cases 7 and 8. In this case, the majority rule holds and the region A2 is recognized as the airspace.

### Case 8

Case 8 is a case where one reference point is present in the region A1 and two reference points are present in the region A2. In this case, the majority rule holds and the region A1 is recognized as the airspace.

### Case 9

Case 9 is a case where three reference points are present in the region A2. In this case, the majority rule holds and the region A1 is recognized as the airspace.

The procedure of Step S14 will be described in more detail.

### Step S141

It is determined whether the number N1 of reference points in the region A1 is equal to or greater than two (N1≧2).

### Step S142

The case where N1≧2 holds corresponds to one of Cases 4, 6, and 7, and thus the region A2 is recognized as the airspace. In this case, the circumferential direction of the boundary of the airspace is clockwise, i.e., the opposite direction. In order to correct the circumferential direction of the boundary of the airspace to counterclockwise, i.e., the forward direction, the defined direction of the airspace is reversed.

### Step S143

When N1<2 holds, it is determined whether the number N2 of vectors in the region A2 is equal to or greater than two (N2≧2).

### Step S144

The case where N2≧2 holds corresponds to one of Cases 5, 8, and 9, and thus the region A1 is recognized as the airspace. In this case, the circumferential direction of the boundary of the airspace is counterclockwise, i.e., the forward direction.

### Step S145

The case where N2<2 holds corresponds to one of Cases 1 to 3 described above, and thus a notification about an error is sent.

As described above, in Step S14, the true circumferential direction of each region can be determined by counting the number of reference points included in each region. In this exemplary embodiment, three reference points are arranged in such a manner that they are spaced apart from each other. Accordingly, the area of one region including more than half of the reference points can be regarded as larger than the area of the other region. Therefore, since the area of the airspace is significantly smaller than the ground surface, the smaller region may be recognized as the airspace. In other words, it can be understood that the airspace information processing device 100 makes a majority decision using reference points, thereby approximately comparing the areas of two regions which are separated by a closed curve.

After that, the circumferential direction of the closed curve surrounding the recognized airspace may be set so as to coincide with the circumferential direction of the closed curve set in the airspace information processing device 100. For example, when the circumferential direction of the airspace is defined as counterclockwise, the direction in which the region including a greater number of vectors output from the closed curve is viewed on the right side corresponds to the circumferential direction of the airspace.

As described above, according to this configuration, a plurality of pieces of information on airspaces defined by closed curves with different circumferential directions can be accurately treated in a unified manner.

### Second Exemplary Embodiment

An airspace information processing device 200 according to a second exemplary embodiment will be described. The airspace information processing device 200 is a modified example of the airspace information processing device according to the first exemplary embodiment. While the airspace information processing device 200 has the same configuration as that of the airspace information processing device 100, but the operation of the airspace information processing device 200 differs from that of the airspace information processing device 100. The airspace information processing device 200 differs from the airspace information processing device 100 in that the airspace information processing device 200 further performs validity determination on the airspace recognition. This validity determination is performed by the airspace recognition unit 2 of the airspace information processing device 200.

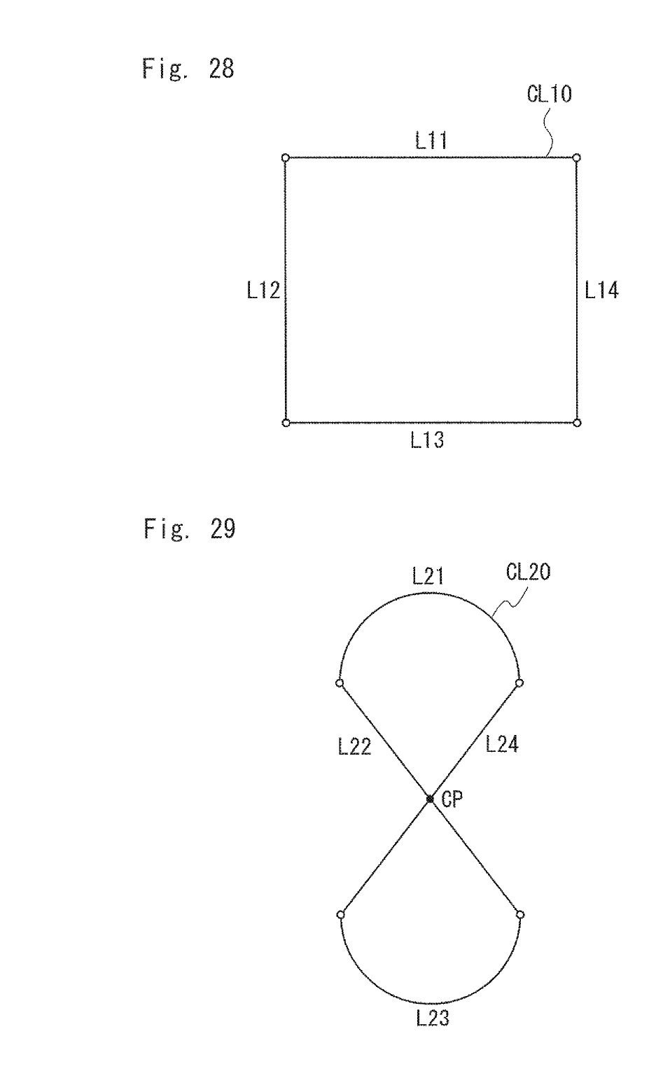

The first exemplary embodiment has been described above assuming that an airspace is defined by a closed curve, but in some cases, a part of one closed curve intersects another part of the closed curve. FIG. 28 is a diagram showing an example of a closed curve with no intersection point. As shown in FIG. 28, when the closed curve has no intersection point, a closed curve CL10 formed of line segments L11 to L14 have a substantially annular shape.

FIG. 29 is a diagram showing an example of a closed curve with an intersection point. In this example, a closed curve CL20 formed of line segments L21 to L24 have a figure eight shape, and the line segment L22 and the line segment L24 have one intersection point CP. In this case, when the airspace recognition described in the first exemplary embodiment is performed, it is difficult to normally recognize an airspace.

Therefore, when a closed curve has an intersection point, there is a need for a function to detect that a closed curve has an intersection point and send a notification about an error. The airspace information is generally set so as to prevent an intersection point from being generated on a closed curve. However, it can be assumed that the airspace information may be erroneously set during data creation or data input. Accordingly, in order to accurately design an airspace, it is necessary to detect a case where a closed curve has an intersection point.

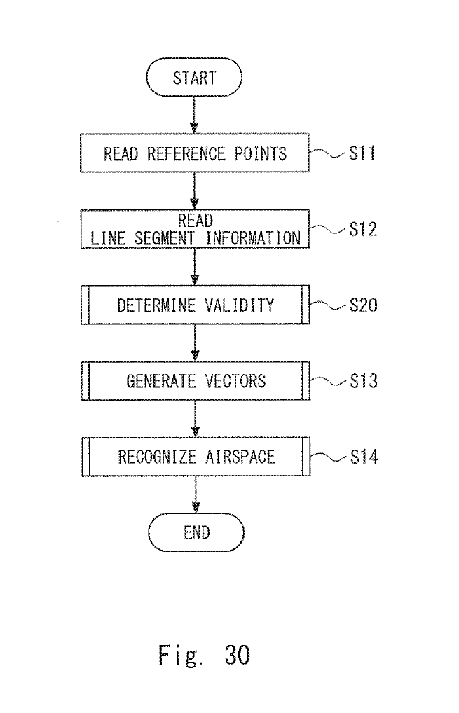

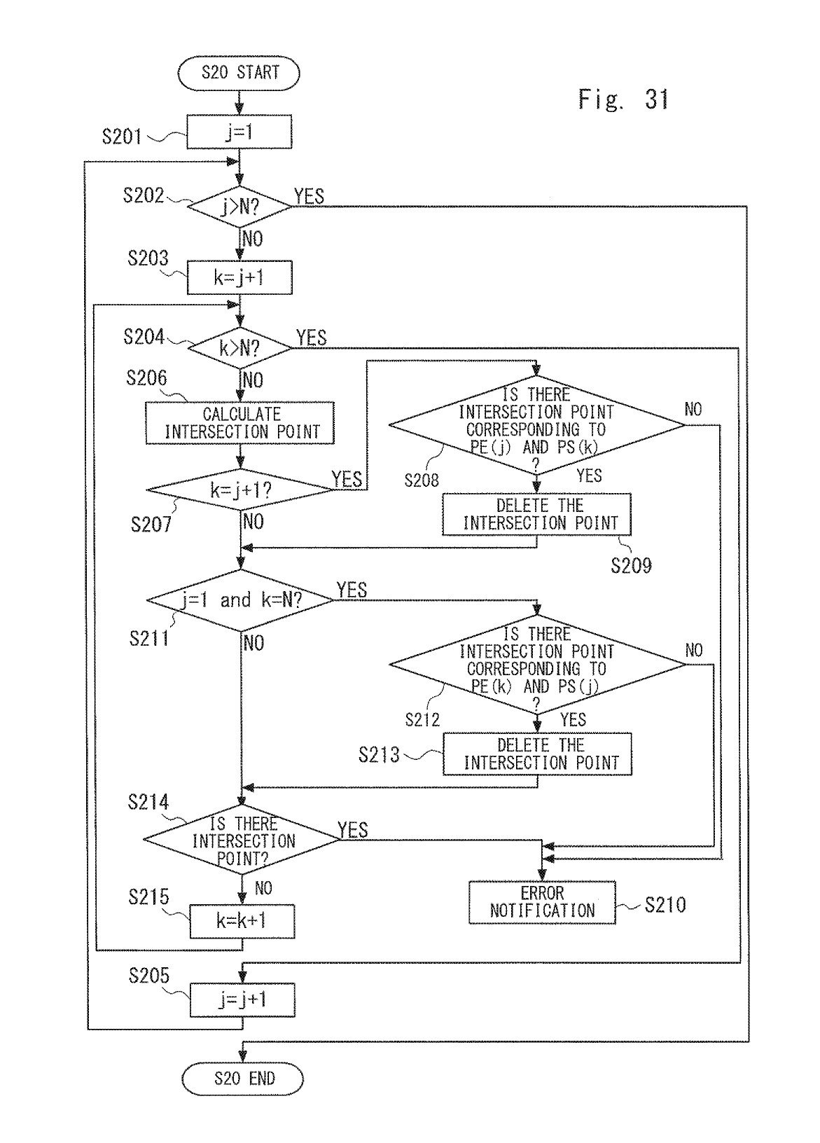

Airspace information processing in the airspace information processing device 200 will be described below. FIG. 30 is a flowchart showing the airspace information processing operation of the airspace information processing device 200 according to the second exemplary embodiment. In the airspace information processing of the airspace information processing device 200, validity determination (Step S20) is added between Steps S12 and S13 of the air information processing of the airspace information processing device 100 shown in FIG. 8.

The validity determination (Step S20) will be described below. FIG. 31 is a flowchart showing vector validity determination processing in the airspace information processing device 100 according to the first exemplary embodiment. In this case, a closed curve that defines an airspace is formed of N (N is an integer equal to or greater than 1) line segments. Each line segment is represented as L(j) using a parameter j (1≦j≦N) and as L(k) using a parameter k (j+1≦k≦N).

### Step S201

The parameter j is set to “1” (j=1).

### Step S202

It is determined whether “j” is greater than “N” (j>N).

When j>N holds, the validity determination (Step S20) is completed.

### Step S203

When “j” is smaller than “N” (j≦N), the parameter k is set to k=j+1.

### Step S204

It is determined whether “k” is greater than “N” (k>N).

### Step S205

When k>N holds, “1” is added to the parameter j (j=j+1). After that, the processing returns to Step S202.

### Step S206

When “k” is equal to or smaller than “N” (k≦N), all intersection points between the line segment L(j) and the line segment L(k) are calculated.

### Step S207

It is determined whether k=j+1 holds.

When k≠j+1 holds, the processing proceeds to Step S211.

### Step S208

When k=j+1 holds in Step S207, it is determined whether the intersection points obtained in Step S205 include an intersection point corresponding to each of an end point PE(j) of the line segment L(j) and a start point PS(k) of the line segment L(k).

### Step S209

In Step S208, when there is an intersection point corresponding to each of the end point PE(j) of the line segment L(j) and the start point PS(k) of the line segment L(k), the intersection point is deleted.

### Step S210

In Step S208, when there is no intersection point corresponding to each of the end point PE(j) of the line segment L(j) and the start point PS(k) of the line segment L(k), it is determined that it is impossible to recognize the airspace. Then, the processing is interrupted and a notification about an error is sent.

### Step S211

It is determined whether j=1 and k=N hold.

When j=1 and k=N do not hold, the processing proceeds to Step S214.

### Step S212

When j=1 and k=N hold in Step S211, it is determined whether there is an intersection point corresponding to each of an end point PE(k) of the line segment L(k) and a start point PS(j) of the line segment L(j).

### Step S213

In Step S212, when there is an intersection point corresponding to each of the end point PE(k) of the line segment L(k) and the start point PS(j) of the line segment L(j), the intersection point is deleted.

### Step S213

In Step S212, there is no intersection point corresponding to each of the end point PE(k) of the line segment L(k) and the start point PS(j) of the line segment L(j), the processing proceeds to Step S210 and it is determined that it is impossible to recognize the airspace. Then, the processing is interrupted and a notification about an error is sent.

### Step S214

It is determined whether there is an intersection point between the line segment L(j) and the line segment L(k).

When there is an intersection point between the line segment L(j) and the line segment L(k), the processing proceeds to Step S210 and it is determined that it is impossible to recognize the airspace. Then, the processing is interrupted and a notification about an error is sent.

### Step S215

When there is no intersection point between the line segments L(j) and L(k), “1” is added to the parameter k (k=k+1). After that, the processing proceeds to Step S204.

According to Steps S201 to S215 described above, a case where the airspace is separated into a plurality of regions can be detected. This prevents false recognition of an airspace, or processing based on the airspace information with which the airspace recognition cannot be achieved.

### Other Exemplary Embodiment

Note that the present invention is not limited to the above exemplary embodiments and can be modified as appropriate without departing from the scope of the invention.

The airspace information processing device and the airspace information processing method performed by the device have been described above. However, the present invention is not limited to these examples. According to the present invention, any processing can be implemented by causing a CPU (Central Processing Unit) to execute a computer program.

The program can be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (random access memory), etc.). The program may be provided to a computer using any type of transitory computer-readable media. Examples of transitory computer-readable media include electric signals, optical signals, and electromagnetic waves. Transitory computer-readable media can provide the program to a computer via a wired communication line (e.g. electric wires, and optical fibers) or a wireless communication line.

In the above exemplary embodiment, the number of reference points is three, but the number of reference points may be any value equal to or greater than four. While the reference points are set on the equator in the above exemplary embodiments, the reference points can be set at any location.

In the above exemplary embodiments, a notification about an error is sent in the cases corresponding to Cases 1 to 3, but this is illustrated by way of example only. For example, the conditions for sending a notification about an error can be changed depending on the airspace design specifications.

While the present invention has been described above with reference to exemplary embodiments, the present invention is not limited by the above exemplary embodiments. The configuration and details of the present invention can be modified in various manners which can be understood by those skilled in the art within the scope of the invention.

### REFERENCE SIGNS LIST

100 AIRSPACE INFORMATION PROCESSING DEVICE
101 AIRSPACE INFORMATION PROCESSING DEVICE
1 VECTOR GENERATION UNIT
1 AIRSPACE RECOGNITION UNIT
2 REFERENCE POINT READING UNIT
4 LINE SEGMENT INFORMATION READING UNIT
5 STORAGE UNIT

What is claimed is:

1. An airspace information processing device comprising:
a vector generation unit configured to select, for each of three or more reference points set at locations spaced apart from each other on a sphere, a line segment to be drawn from each of the three or more reference points without intersecting another line segment, from among one or more line segments forming an airspace defined by a closed curve on the sphere, and generating, for each of the three or more reference points, a vector from the selected line segment to each of the reference points; and
an airspace recognition unit configured to recognize one of two regions on a true sphere as an outside of the airspace and recognizing the other region as the airspace, the two regions being separated by the closed curve, the one of the two regions including the vectors of more than half of the three or more reference points.

2. The airspace information processing device according to claim 1, further comprising:
a storage unit configured to the three or more reference points and line segment information indicating one or more line segments which form the closed curve;
a reference point reading unit configured to read the three or more reference points from the storage unit, and outputting a result of the reading to the vector generation unit; and
a line segment information reading unit configured to read the line segment information from the storage unit, and outputting a result of the reading to the vector generation unit.

3. The airspace information processing device according to claim 1, wherein
the vector generation unit selects one line segment from the one or more line segments, and draws a first line segment from an arbitrary point on the selected line segment to the selected reference point,
the vector generation unit selects one reference point from the three or more reference points,
the vector generation unit calculates intersection points between the first line segment and line segments other than the selected line segment,
the vector generation unit selects, from among the intersection points, an intersection point closest to the selected reference point, and
the vector generation unit generates a vector from the selected intersection point to the selected reference point.

4. The airspace information processing device according to claim 1, wherein
when the number of vectors present in a first region is more than half of the three or more reference points, the airspace recognition unit recognizes a second region as the airspace, the first region being one of two regions on the true sphere, the two regions being separated by the closed curve, the second region being the other one of the two regions,
when the number of vectors present in the second region is more than half of the three or more reference points, the airspace recognition unit recognizes the first region as the airspace, and
when more than half of the three or more reference points are not present in either of the first region and the second region, the airspace recognition unit sends a notification about an error.

5. An airspace information processing method comprising:
reading information indicating three or more reference points set at locations spaced apart from each other on a sphere;
reading information indicating a line segment forming an airspace defined by a closed curve formed of one or more line segments on the sphere;
selecting, for each of the reference points, a line segment to be drawn from each of the reference points to the one or more line segments without intersecting another line segment;
generating, for each of the reference points, a vector from the selected line segment to each of the reference points; and
recognizing one of two regions on a true sphere as an outside of the airspace and recognizing the other region as the airspace, the two regions being separated by the closed curve, the one of the two regions including the vectors of more than half of the three or more reference points.

6. A non-transitory computer-readable medium storing an airspace information processing program for causing a computer to execute:
processing for reading information indicating three or more reference points set at locations spaced apart from each other on a sphere;
processing for reading information indicating a line segment forming the airspace defined by a closed curve formed of one or more line segments on the sphere;
processing for selecting, for each of the reference points, a line segment to be drawn from each of the reference points to the one or more line segments without intersecting another line segment;
processing for generating, for each of the reference points, a vector from the selected line segment to each of the reference points; and
processing for recognizing one of two regions on a true sphere as an outside of the airspace and recognizing the other region as the airspace, the two regions being separated by the closed curve, the one of the two regions including the vectors of more than half of the three or more reference points.
